(19) United States
(12) Patent Application Publication
(10) Pub. No.: US 2023/0151301 A1
(43) Pub. Date: May 18, 2023

(54) WATER-BASED SILICONE COMBINATION SURFACE MODIFICATION COMPOSITIONS AND METHODS OF USE THEREOF

(71) Applicant: Energizer Auto, Inc., St. Louis, MO (US)

(72) Inventors: Grace Nabil Mahfouz, Rocky River, OH (US); Chase Southwick Naisbitt, Columbia Station, OH (US); Hirotaka Uchiyama, Loveland, OH (US); Cindy Luna-Zaragoza, Tipp City, OH (US); Rajeev Menon, Dayton, OH (US)

(21) Appl. No.: 17/915,994

(22) PCT Filed: Apr. 20, 2021
(86) PCT No.: PCT/US2021/028131

§ 371 Date: Sep. 29, 2022

Related U.S. Application Data
(60) Provisional application No. 63/013,014, filed on Apr. 21, 2020.
(60) Provisional application No. 63/013,039, filed on Apr. 21, 2020.

(51) Int. Cl. C11D 1/00; C11D 3/37; C11D 3/00; C11D 3/43; C11D 17/00; C11D 11/00

(52) U.S. Cl. CPC C11D 1/008; C11D 3/373; C11D 3/0073; C11D 3/43; C11D 17/0017; C11D 11/0023; C11D 17/0043; C11D 1/82

(57) ABSTRACT

Described herein are compositions and methods for use in automotive care. In particular, the present disclosure is directed to water-based compositions comprising silicone combinations that delivery cleaning, protective, preservative and shine qualities.

### CROSS-REFERENCE TO RELATED APPLICATIONS

This application claims priority to U.S. Provisional Application Ser. No. 63/013,039, filed on Apr. 21, 2020, and U.S. Provisional Application Ser. No. 63/013,014, filed on Apr. 21, 2020, the contents of which are hereby incorporated by reference in their entirety.

### FIELD OF THE DISCLOSURE

Described herein are compositions and methods for use in automotive care. In particular, the present disclosure is directed to water-based compositions comprising silicone combinations that deliver cleaning, protective, preservative and shine qualities.

### BACKGROUND OF THE DISCLOSURE

Automotive products currently on the market offer to provide hydrophobic effects on car surfaces, however, there are various drawbacks and issues with these products. Moreover, one must use multiple products to deliver hydrophobicity, durability, shine and antistatic properties.

There remains a need, therefore, to provide an automotive surface modification composition—in one product—that is capable to deliver protection, preservation, shine and cleanliness to the surface, meanwhile providing an improved hydrophobic effect.

### SUMMARY OF THE DISCLOSURE

In one aspect, the present disclosure is directed to a composition comprising: a non-ionic amino functional silicone emulsion; a cationic and non-ionic silicone blend comprising a long-chain silicone quaternium; and a polydimethylsiloxane emulsion.

In another aspect, the present disclosure is directed to method of treating an automotive surface, the method comprising: applying a composition to an automotive surface, wherein the composition comprises: a non-ionic amino functional silicone emulsion; a cationic and non-ionic silicone blend comprising a long-chain silicone quaternium; and a polydimethylsiloxane emulsion.

### BRIEF DESCRIPTION OF THE DRAWINGS

FIG. 1A depicts a dirty car surface before application of a composition in accordance with the present disclosure.

FIG. 1B depicts a clean car surface after application of a composition in accordance with the present disclosure.

FIG. 2A depicts a dirty car surface covered with water spots before application of a composition in accordance with the present disclosure.

FIG. 2B depicts a clean car surface not covered with water spots after application of a composition in accordance with the present disclosure.

FIG. 3A depicts a dirty car surface covered with pollen before application of a composition in accordance with the present disclosure.

FIG. 3B depicts a clean car surface not covered with pollen after application of a composition in accordance with the present disclosure.

FIG. 4A depicts a dirty car surface covered with dust before application of a composition in accordance with the present disclosure.

FIG. 4B depicts a clean car surface not covered with dust after application of a composition in accordance with the present disclosure.

FIG. 5A depicts a dirty car surface covered with grime before application of a composition in accordance with the present disclosure.

FIG. 5B depicts a clean car surface not covered with grime after application of a composition in accordance with the present disclosure.

FIG. 6A depicts a dirty car surface covered with clay before application of a composition in accordance with the present disclosure.

FIG. 6B depicts a clean car surface not covered with clay after application of a composition in accordance with the present disclosure.

FIG. 7A depicts a dirty car surface covered with mud before application of a composition in accordance with the present disclosure.

FIG. 7B depicts a clean car surface not covered with mud after application of a composition in accordance with the present disclosure.

FIG. 8A depicts an untreated dirty car surface covered with dust before removal of the dust by wiping.

FIG. 8B depicts a dirty car surface treated with a composition in accordance with the present disclosure and then covered with dust.

FIG. 8C depicts an untreated clean car surface not covered with dust after removal of the dust by wiping.

FIG. 8D depicts a clean car surface treated with a composition in accordance with the present disclosure not covered with dust after removal of the dust by wiping.

### DETAILED DESCRIPTION OF THE DISCLOSURE

Described herein are compositions and methods for use, for example, in the automotive care industry. For example, the compositions of the present disclosure address the need for a complete exterior automotive surface detailer that is capable to deliver cleaning, protection, preservation, shine and being able to be used as a clay lubricant.

In many embodiments, the composition cleans by safely loosening and removing dust, grime, pollen, water spots, clay residue and/or other surface contaminants.

In many embodiments, the composition preserves surfaces and does not strip away wax or polish.

In many embodiments, the composition provides a long-lasting shine.

In many embodiments, the composition protects surfaces by implementing hydrophobic polymers to repel water and dust.

In many embodiments, the composition is a high-lubricity formula that can be used with clay bars.

In some embodiments, this detailer has three silicone components, each with a particular function. For example, one silicone is an amino-functional silicone emulsion for durability and hydrophobicity. Another silicone is comprised of antistatic properties and repels dirt/dust. The third silicone in an emulsion that provides shining properties.

The compositions of the present disclosure provide an improved hydrophobic effect on an automotive surface compared to previously known products, with the highest contact angle on a painted car surface. The compositions also provide a deep, long lasting shine. Applying the composition to the surface of a car has proven, for example, to reduce the coefficient of friction and thus has improved dust-repelling properties.

In some embodiments, the composition comprises a non-ionic amino functional silicone emulsion; a cationic and non-ionic silicone blend comprising a long-chain silicone quaternium; and a polydimethylsiloxane emulsion. In some embodiments, the composition is used as part of a method to treat an automotive surface by applying the composition to the automotive surface.

In some embodiments of the present disclosure, the non-ionic amino functional silicone emulsion contributes to the hydrophobicity and durability of the composition. In some embodiments, the non-ionic amino functional silicone emulsion comprises an aminoalkyl-functional organopolysiloxane fluid and water. In some embodiments, the aminoalkyl-functional organopolysiloxane fluid is selected from the group consisting of an amine-alkyl/dimethyl copolymer, a polar amine/alkyl functional block, an amine/alkoxy end-blocked silicone, and combinations thereof. In some embodiments, the non-ionic amino functional silicone emulsion is selected from the group consisting of APS-385B, Siltech E-4135, and Elkay LK Primasoft Power.

In some embodiments, the non-ionic amino functional silicone emulsion is soluble in water. In some embodiments, the non-ionic amino functional silicone emulsion is present in an amount of from about 0.1% to about 10%, from about 0.5% to about 7%, from about 1% to about 5%, or about 2.5% by weight of the composition.

In some embodiments of the present disclosure, the cationic and non-ionic silicone blend provides the composition with antistatic and dirt- and/or dust-repelling properties. In some embodiments, the cationic and non-ionic silicone blend is present in an amount of from about 0.01% to about 2%, from about 0.1% to about 1%, from about 0.25% to about 0.75%, or about 0.5% by weight of the composition. In some embodiments, the cationic and non-ionic silicone blend is Tego Polish Additive Q70. In some embodiments, the cationic and non-ionic silicone blend comprises a long-chain silicone quaternium. In some embodiments, the cationic and non-ionic silicone blend is soluble in water.

In some embodiments, the composition comprises a polydimethylsiloxane emulsion. The polydimethylsiloxane emulsion provides the composition with shine properties. In some embodiments, the polydimethylsiloxane emulsion is soluble in water.

In some embodiments, the polydimethylsiloxane emulsion comprises 60% silicone. In some embodiments, the polydimethylsiloxane emulsion is Momentive SM2163 NPF.

In some embodiments of the present disclosure, the polydimethylsiloxane emulsion is present in an amount of from about 1% to about 10%, from about 2% to about 7%, from about 3% to about 5%, or about 4% by weight of the composition.

In some embodiments, the composition comprises a combination of three silicones, each with a unique purpose in the composition. APS-385B, for example, is a non-ionic amino functional silicone emulsion for hydrophobicity and durability. Tego Polish Additive Q70, for example, is a cationic and non-ionic blend containing a long-chain silicone quaternium, added for its antistatic and dust-repelling properties. Momentive SM2163 NPF, for example, is a 60% Polydimethylsiloxane emulsion used for its shine properties in some combinations in accordance with the present disclosure.

In some embodiments, the composition further comprises a corrosion inhibitor. In some embodiments, the corrosion inhibitor comprises 2-propyn-1-ol, ethanolamine, at least one quaternary compound, propanol, 2- and water. In some embodiments, the corrosion inhibitor is selected from the group consisting of Metal Guard 816, Aqualox 232H and AMP 95. In some embodiments, the corrosion inhibitor is present in an amount of from about 0.01% to about 3.0%, from about 0.05 to about 1.0%, or about 0.15% by weight of the composition.

In some embodiments, the composition further comprises a cleaning solvent. In some embodiments, the cleaning solvent is selected from the group consisting of butyl carbitol and 2-butoxyethanol. In some embodiments, the cleaning solvent is present in an amount of from about 0.1% to about 5%, from about 0.5% to about 3%, or about 1% by weight of the composition.

In some embodiments, the composition further comprises a pH adjuster. In some embodiments, the pH adjuster is selected from the group consisting of citric acid, hydrochloric acid and acetic acid. In some embodiments, the pH adjuster is present in an amount that results in the composition having a pH of about 7. In some embodiments, the composition has a pH of from about 6 to about 7. In some embodiments, the composition comprises from about 0.001 g to about 1.0 g, or from about 0.005 g to about 0.01 g of the pH adjuster. In some embodiments, the pH adjuster is anhydrous. In some embodiments, the pH adjuster is present in an amount of about 0.0155% by weight of the composition, and the pH of the composition is about 6.5.

In some embodiments, the composition further comprises a cationic surfactant. In some embodiments, the cationic surfactant comprises at least one quaternary ammonium compound, benzyl-C12-16-alkyldimethyl, at least one chloride, ethanol and water. In some embodiments, the cationic surfactant is Uniquat QAC-50. In some embodiments, the cationic surfactant is present in an amount of from about 0.01% to about 1%, from about 0.05% to about 0.75%, from about 0.1% to about 0.5%, or about 0.2% by weight of the composition.

In some embodiments, the composition further comprises water. In some embodiments, the water is present in an amount of from about 65% to about 95% from about 70% to about 90%, from about 70% to 85%, or about 82% by weight of the composition.

In some embodiments, the composition comprises the following formula:

| Material | Formula % (wt/wt) | Function |
|---|---|---|
| DI Water | 90.635% | Diluent |
| APS-385B | 2.50% | Hydrophobicity and |
| | | durability |
| Metal Guard 816 | 0.15% | Corrosion inhibitor |
| Tego Polish Additive | 0.50% | Antistatic/Repels |
| Q70 | | dust |
| Momentive SM2163 | 4.00% | Shine |
| NPF | | |
| Butyl Carbitol | 1.00% | Cleaning solvent |
| Citric Acid | 0.0155% | pH adjuster |
| (anhydrous) to pH 7 | | |
| Uniquat QAC-50 | 0.20% | Surfactant |
| DI Water to 100% | 1.00% | |
| Total (%) | 100.00% | |
| pH (pH paper and meter) | ~7 | |
| pH range 6-7 | 6.9 (pH meter) | |
| Viscosity | Water-thin | |
| Appearance | Milky white | Diluent |

In some embodiments of the present disclosure, the composition is applied to an automotive surface. In some embodiments, the automotive surface is selected from the group consisting of a tire, wheel, glass, paint, hood, roof, trunk, an exterior part, an interior part, and combinations thereof. In some embodiments, the composition is a fluid, such as a liquid, and the liquid is applied by the means of an aerosol, a trigger sprayer, a sponge, a microfiber cloth, and combinations thereof. In some embodiments, the composition is sprayed on a car surface and then wiped off the car surface.

The embodiments of this disclosure include:

1. A composition comprising:

a non-ionic amino functional silicone emulsion;

a cationic and non-ionic silicone blend comprising a long-chain silicone quaternium; and

a polydimethylsiloxane emulsion.

2. The composition of claim 1, wherein the non-ionic amino functional silicone emulsion comprises an aminoalkyl-functional organopolysiloxane fluid and water.

3. The composition of claim 2, wherein the aminoalkyl-functional organopolysiloxane fluid is selected from the group consisting of an amine-alkyl/dimethyl copolymer, a polar amine/alkyl functional block, an amine/alkoxy end-blocked silicone, and combinations thereof.

4. The composition of claim 1, wherein the non-ionic amino functional silicone emulsion is selected from the group consisting of APS-385B, Siltech E-4135, and Elkay LK Primasoft Power.

5. The composition of claim 1, wherein the non-ionic amino functional silicone emulsion is soluble in water.

6. The composition of claim 1, wherein the non-ionic amino functional silicone emulsion is present in an amount of from about 0.1% to about 10%, from about 0.5% to about 7%, from about 1% to about 5%, or about 2.5% by weight of the composition.

7. The composition of claim 1, wherein the cationic and non-ionic silicone blend is Tego Polish Additive Q70.

8. The composition of claim 1, wherein the cationic and non-ionic silicone blend is present in an amount of from about 0.01% to about 2%, from about 0.1% to about 1%, from about 0.25% to about 0.75%, or about 0.5% by weight of the composition.

9. The composition of claim 1, wherein the cationic and non-ionic silicone blend is soluble in water.

10. The composition of claim 1, wherein the polydimethylsiloxane emulsion comprises 60% silicone.

11. The composition of claim 1, wherein the polydimethylsiloxane emulsion is Momentive SM2163 NPF.

12. The composition of claim 1, wherein the polydimethylsiloxane emulsion is present in an amount of from about 1% to about 10%, from about 2% to about 7%, from about 3% to about 5%, or about 4% by weight of the composition.

13. The composition of claim 1, wherein the polydimethylsiloxane emulsion is soluble in water.

14. The composition of claim 1, further comprising a corrosion inhibitor.

15. The composition of claim 14, wherein the corrosion inhibitor comprises 2-propyn-1-ol, ethanolamine, at least one quaternary compound, propanol, 2- and water.

16. The composition of claim 14, wherein the corrosion inhibitor is selected from the group consisting of Metal Guard 816, Aqualox 232H and AMP 95.

17. The composition of claim 14, wherein the corrosion inhibitor is present in an amount of from about 0.01% to about 3.0%, from about 0.05 to about 1.0%, or about 0.15% by weight of the composition.

18. The composition of claim 1, further comprising a cleaning solvent.

19. The composition of claim 18, wherein the cleaning solvent is selected from the group consisting of butyl carbitol and 2-butoxyethanol.

20. The composition of claim 18, wherein the cleaning solvent is present in an amount of from about 0.1% to about 5%, from about 0.5% to about 3%, or about 1% by weight of the composition.

21. The composition of claim 1, further comprising a pH adjuster.

22. The composition of claim 21, wherein the pH adjuster is selected from the group consisting of citric acid, hydrochloric acid and acetic acid.

23. The composition of claim 21, wherein the pH adjuster is present in an amount that results in the composition having a pH of about 7.

24. The composition of claim 21, comprising from about 0.001 g to about 1.0 g, or from about 0.005 g to about 0.01 g of the pH adjuster.

25. The composition of claim 21, wherein the pH adjuster is anhydrous.

26. The composition of claim 21, wherein the pH adjuster is present in an amount of about 0.0155% by weight of the composition, and the pH of the composition is about 6.5.

27. The composition of claim 1, further comprising a cationic surfactant.

28. The composition of claim 27, wherein the cationic surfactant comprises at least one quaternary ammonium compound, benzyl-C12-16-alkyldimethyl, at least one chloride, ethanol and water.

29. The composition of claim 27, wherein the cationic surfactant is Uniquat QAC-50.

30. The composition of claim 27, wherein the cationic surfactant is present in an amount of from about 0.01% to about 1%, from about 0.05% to about 0.75%, from about 0.1% to about 0.5%, or about 0.2% by weight of the composition.

31. The composition of claim 1, further comprising water.

32. The composition of claim 31, wherein the water is present in an amount of from about 65% to about 95%, from about 70% to about 92%, or about 91.635% by weight of the composition.

33. The composition of claim 1, wherein the composition has a pH of from about 6 to about 7.

34. The composition of claim 1, wherein the composition is applied to an automotive surface.

35. The composition of claim 34, wherein the automotive surface is selected from the group consisting of a tire, wheel, glass, paint, hood, roof, trunk, an exterior part, an interior part, and combinations thereof.

36. The composition of claim 1, wherein the composition is a fluid, such as a liquid, and the liquid is applied by the means of an aerosol, a trigger sprayer, a sponge, a microfiber cloth, or combinations thereof.

37. A method of treating an automotive surface, the method comprising:
applying a composition to an automotive surface, wherein the composition comprises:
a non-ionic amino functional silicone emulsion;
a cationic and non-ionic silicone blend comprising a long-chain silicone quaternium; and
a polydimethylsiloxane emulsion.

### EXAMPLES

Without further elaboration, it is believed that one skilled in the art using the preceding description can utilize the present invention to its fullest extent. The following Examples are, therefore, to be construed as merely illustrative, and not limiting of the disclosure in any way whatsoever.

### Example 1: Application

The compositions according to the present disclosure can be provided in a bottle. A user can apply the composition by shaking the bottle well, spraying the composition onto a surface, and wiping the composition from the surface.

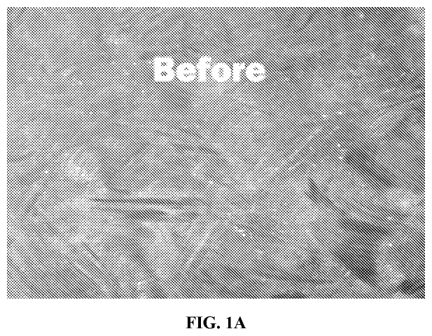

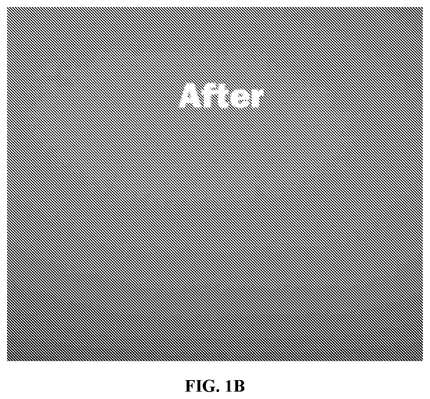

Application of a composition in accordance with the present disclosure is shown in FIGS. 1A and 1B. FIG. 1A depicts a dirty car surface before application of a composition in accordance with the present disclosure. FIG. 1B depicts a clean car surface after application of a composition in accordance with the present disclosure. As can be seen, the composition cleans.

### Example 2: Cleaning

A difference of less than about 10% in gloss and RGB data was measured between an untreated painted surface and a painted surface treated with a composition in accordance with the present disclosure. Dirtied surfaces were dirtied with dust, grime, pollen, water spots, clay residue, and/or other surface contaminants. This indicates that the surface is being cleaned from all these soils.

### Example 3: Water Spots

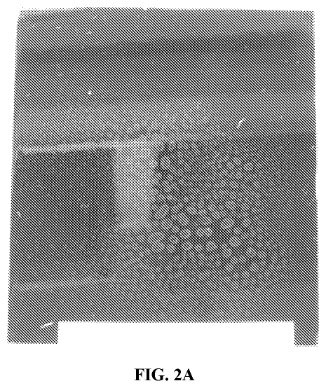

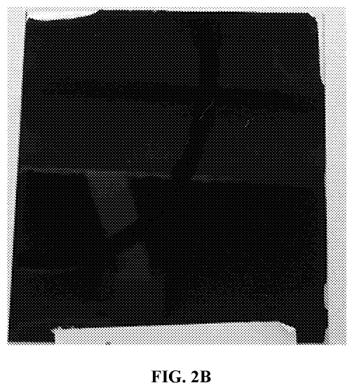

Application of a composition in accordance with the present disclosure is shown in FIGS. 2A and 2B. Water was applied to a surface and water spots formed. These water spots remained until the next day when the surface was treated with a composition in accordance with the present disclosure. As can be seen, the water spots were removed by the composition in accordance with the present disclosure.

### Example 4: Pollen

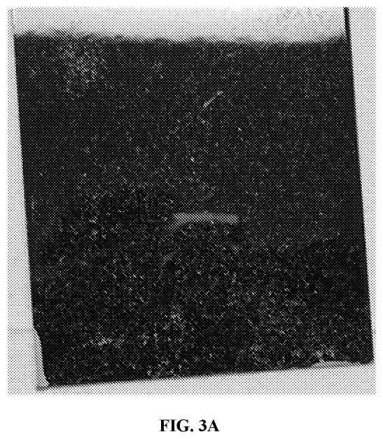

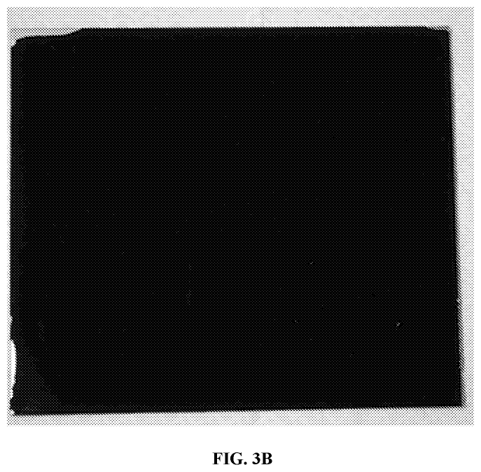

Application of a composition in accordance with the present disclosure is shown in FIGS. 3A and 3B. Pollen was applied to a surface. The pollen remained until the next day. Pollen was tapped off the surface and the surface was treated with a composition in accordance with the present disclosure. As can be seen, the pollen was removed by the composition in accordance with the present disclosure.

### Example 5: Dust

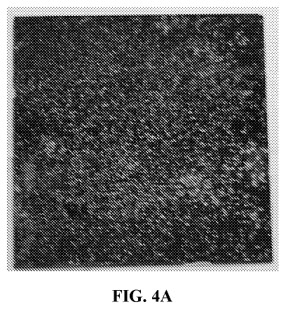

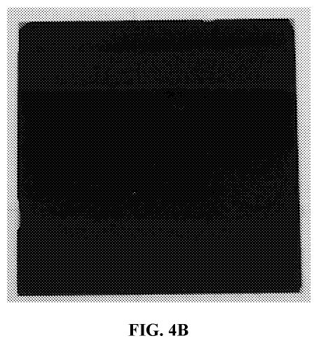

Application of a composition in accordance with the present disclosure is shown in FIGS. 4A and 4B. Dust was applied to a surface. The dust remained until the next day. The dust was tapped off the surface and the surface was treated with a composition in accordance with the present disclosure. As can be seen, the dust was removed by the composition in accordance with the present disclosure.

### Example 6: Grime

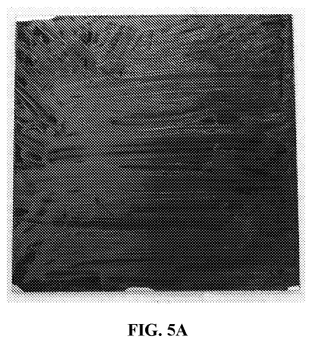

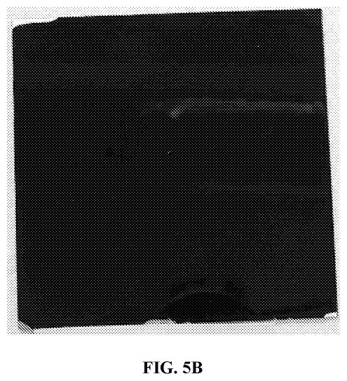

Application of a composition in accordance with the present disclosure is shown in FIGS. 5A and 5B. Grime was applied to a surface. The grime remained until the next day. The surface was treated with a composition in accordance with the present disclosure. As can be seen, the grime was removed by the composition in accordance with the present disclosure.

### Example 7: Clay

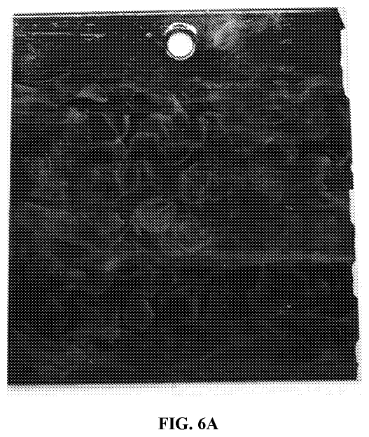

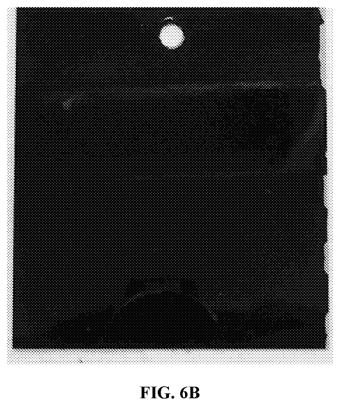

Application of a composition in accordance with the present disclosure is shown in FIGS. 6A and 6B. Clay was applied to a surface. The clay remained until the next day. The surface was treated with a composition in accordance with the present disclosure. As can be seen, the clay was removed by the composition in accordance with the present disclosure.

### Example 8: Mud

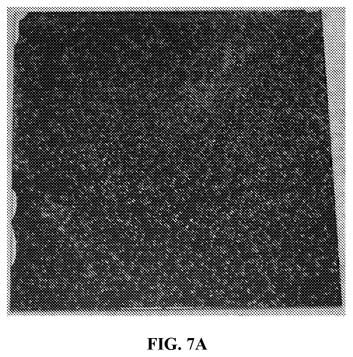

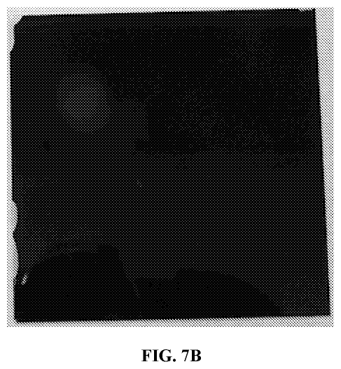

Application of a composition in accordance with the present disclosure is shown in FIGS. 7A and 7B. Mud was applied to a surface. The mud remained until the next day. The mud was tapped off the surface and the surface was treated with a composition in accordance with the present disclosure. As can be seen, the mud was removed by the composition in accordance with the present disclosure.

### Example 9: Water Beading

Water repellency was tested by measuring the contact angle of treated painted metal panels. The contact angle of a painted metal surface treated with a composition in accordance with the present disclosure is 93% higher than the contact angle of an untreated painted metal surface (car hood), which indicates that the composition in accordance with the present disclosure imparts hydrophobicity to the surface and provides water beading and/or repellency.

### Example 10: Dust Repellency

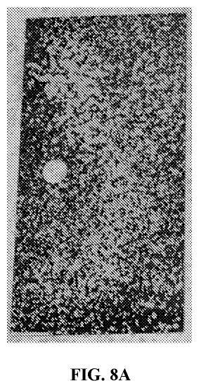

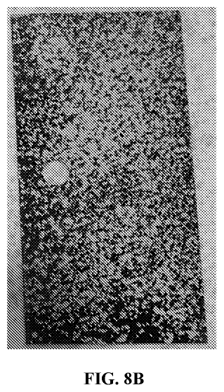

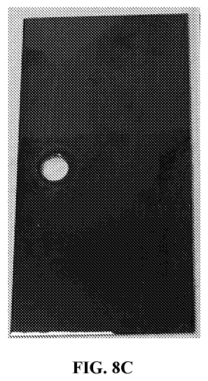

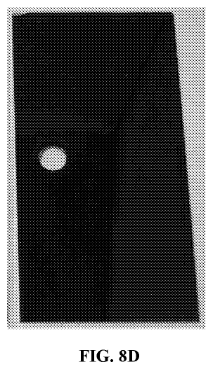

Application of a composition in accordance with the present disclosure is shown in FIGS. 8A-8D. Dust was applied to an untreated surface and a surface pre-treated with a composition in accordance with the present disclosure. The dust was wiped off both surfaces. There was less than a 3% difference in gloss and RGB data between a freshly treated surface and the surface treated with a composition in accordance with the present disclosure for the after dust removal values, which indicates that the composition in accordance with the present disclosure repels dust. Similarly, the contact angle data show less than a 7% difference between a freshly treated surface and the surface treated with a composition in accordance with the present disclosure for the after dust removal values.

### Example 11: Coefficient of Friction (COF)

A composition in accordance with the present disclosure was measured to have about a 43% drop in COF for untreated painted surfaces compared to painted surfaces treated with a composition in accordance with the present disclosure, which indicates increased slip to the surface and the ability to repel dust.

### Example 12: Preservation (Polish)

Gloss and RGB data were measured to have less than a 3% difference between surfaces treated with a polish and surfaces treated with a polish and subsequently treated with a composition in accordance with the present disclosure, which indicates that the composition in accordance with the present disclosure does not strip the polish. Similarly, contact angle data were measured to have less than a 6% difference between surfaces treated with a polish and surfaces treated with a polish and subsequently treated with a composition in accordance with the present disclosure, which indicates that the composition in accordance with the present disclosure does not damage the polish. In addition, Fourier-transform infrared spectroscopy (FTIR) data indicated that treating a painted metal surface that has already been polished with a liquid polish with a composition in accordance with the present disclosure does not strip the polish layer from the surface.

### Example 13: Preservation (Wax)

Gloss and RGB data were measured to have less than a 2% difference between surfaces treated with a carnauba wax and surfaces treated with a carnauba wax and subsequently treated with a composition in accordance with the present disclosure, which indicates that the composition in accordance with the present disclosure does not strip the wax. Similarly, contact angle data were measured to have less than a 1% difference between surfaces treated with a carnauba wax and surfaces treated with a carnauba wax and subsequently treated with a composition in accordance with the present disclosure, which indicates that the composition in accordance with the present disclosure does not damage the wax.

### Example 14: Gloss

A difference of about 35% in gloss @ 60° was measured between an untreated car hood and a car hood treated with a composition in accordance with the present disclosure.

A difference of about 65% in gloss @ 60° was measured between an untreated plastic trim and a plastic trim treated with a composition in accordance with the present disclosure.

### Example 15: Safety

No differences in gloss or RGB readings were observed between a painted metal panel and a painted metal panel after treatment with a composition in accordance with the present disclosure.

No differences in gloss or RGB readings were observed between a glass panel and a glass panel after treatment with a composition in accordance with the present disclosure.

A composition in accordance with the present disclosure was observed to leave a shinier and richer black trim surface after treatment.

This written description uses examples to illustrate the present disclosure, including the best mode, and also to enable any person skilled in the art to practice the disclosure, including making and using any compositions or systems and performing any incorporated methods. The patentable scope of the disclosure is defined by the claims, and may include other examples that occur to those skilled in the art. Such other examples are intended to be within the scope of the claims if they have elements that do not differ from the literal language of the claims, or if they include equivalent elements with insubstantial differences from the literal language of the claims.

As used herein, the terms “comprises,” “comprising,” “includes,” “including,” “has,” “having,” “contains”, “containing,” “characterized by” or any other variation thereof, are intended to cover a non-exclusive inclusion, subject to any limitation explicitly indicated. For example, a composition, mixture, process or method that comprises a list of elements is not necessarily limited to only those elements but may include other elements not expressly listed or inherent to such composition, mixture, process or method.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Where an invention or a portion thereof is defined with an open-ended term such as “comprising,” it should be readily understood that (unless otherwise stated) the description should be interpreted to also describe such an invention using the terms “consisting essentially of” or “consisting of.”

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

As used herein, the term “about” means plus or minus 10% of the value.

What is claimed is:

1. A composition comprising:
a non-ionic amino functional silicone emulsion;
a cationic and non-ionic silicone blend comprising a long-chain silicone quaternium; and
a polydimethylsiloxane emulsion.

2. The composition of claim 1, wherein the non-ionic amino functional silicone emulsion comprises an aminoalkyl-functional organopolysiloxane fluid and water.

3. The composition of claim 1, wherein the non-ionic amino functional silicone emulsion is present in an amount of from about 0.1% to about 10% by weight of the composition.

4. The composition of claim 1, wherein the cationic and non-ionic silicone blend is present in an amount of from about 0.01% to about 2% by weight of the composition.

5. The composition of claim 1, wherein the polydimethylsiloxane emulsion is present in an amount of from about 1% to about 10% by weight of the composition.

6. The composition of claim 1, further comprising a corrosion inhibitor.

7. The composition of claim 6, wherein the corrosion inhibitor is present in an amount of from about 0.01% to about 3.0% by weight of the composition.

8. The composition of claim 1, further comprising a cleaning solvent.

9. The composition of claim 8, wherein the cleaning solvent is present in an amount of from about 0.1% to about 5% by weight of the composition.

10. The composition of claim 1, further comprising a pH adjuster.

11. The composition of claim 10, wherein the pH adjuster is present in an amount that results in the composition having a pH of about 7.

12. The composition of claim 10, comprising from about 0.001 g to about 1.0 g of the pH adjuster.

13. The composition of claim 1, further comprising a cationic surfactant.

14. The composition of claim 13, wherein the cationic surfactant is present in an amount of from about 0.01% to about 1% by weight of the composition.

15. The composition of claim 1, further comprising water.

16. The composition of claim 15, wherein the water is present in an amount of from about 65% to about 95% by weight of the composition.

17. The composition of claim 1, wherein the composition has a pH of from about 6 to about 7.

18. A method of treating an automotive surface, the method comprising:
applying a composition to an automotive surface, wherein the composition comprises:
a non-ionic amino functional silicone emulsion;
a cationic and non-ionic silicone blend comprising a long-chain silicone quaternium; and
a polydimethylsiloxane emulsion.

19. The method of claim 18, wherein the automotive surface is selected from the group consisting of a tire, wheel, glass, paint, hood, roof, trunk, an exterior part, an interior part, and combinations thereof.

20. The method of claim 18, wherein the composition is a fluid and the liquid is applied by the means of an aerosol, a trigger sprayer, a sponge, a microfiber cloth, or combinations thereof.
